(19) United States
(12) Patent Application Publication
(10) Pub. No.: US 2013/0010210 A1
(43) Pub. Date: Jan. 10, 2013

(54) LIGHTING DEVICE, DISPLAY DEVICE AND TELEVISION RECEIVER

(75) Inventor: Shiyoshi Cho, Osaka-shi (JP)

(73) Assignee: SHARP KABUSHIKI KAISHA, Osaka-shi, Osaka (JP)

(21) Appl. No.: 13/637,055

(22) PCT Filed: Mar. 2, 2011
(86) PCT No.: PCT/JP2011/054717

§ 371 Date: Sep. 25, 2012

(30) Foreign Application Priority Data
Apr. 16, 2010 (JP) 2010-095295

(51) Int. Cl. F21V 15/01; H04N 5/66; G02F 1/13357

(52) U.S. Cl. 348/739; 362/382; 349/61; 348/E05.133

(57) ABSTRACT

A backlight unit includes a discharge tube, a backlight chassis and a reinforcing member. The backlight chassis includes a bottom plate and side plates that rise from a surface of the bottom plate at the respective edges of the bottom plate. The backlight chassis houses the discharge tube that is arranged on the first surface of the bottom plate. The reinforcing member includes fixing portions that is fixed to the respective side plates and a reinforcing portion that is in contact with a rear surface of the bottom plate of the backlight chassis and connected to the fixing portions.

### TECHNICAL FIELD

The present invention relates to a lighting device, a display device and a television receiver.

### BACKGROUND ART

A backlight unit disclosed in Patent Document 1 is known as an example of widely known backlight units included in display devices. In the backlight unit, a plurality of lamps (discharge tubes) are housed in a backlight chassis. The lamps are cold cathode fluorescent tubes. The brightness of light emitted from the lamps is controlled by turning on and off the lamps at predetermined intervals. Specifically, the lamps are driven by pulse width modulation signals (by a PWM method) illustrated in FIG. 10.

Patent Document 1: Japanese Unexamined Patent Publication No. 2006-134856

### Problem to be Solved by the Invention

In the backlight unit in Patent Document 1, if the lamps that are housed in the backlight chassis are driven by the PWM method, the lamps and the backlight chassis may cause resonance according to on and off of the pulse signals. As a result, a bottom plate of the backlight chassis vibrates resulting in a buzz sound and a decrease in quality of the backlight unit.

### DISCLOSURE OF THE PRESENT INVENTION

The present invention was accomplished in view of the above circumstances. It is an object of the present invention to provide a lighting device that hardly or is less likely to produce a buzz sound with a simple configuration.

### Means for Solving the Problem

To solve the above problem, a lighting device according to the present technology includes a discharge tube, a housing member and a reinforcing member. The housing member includes a side plate and a bottom plate having a first surface and a second surface. The side plate rises from the first surface of the bottom plate at an edge of the bottom plate. The housing member houses the discharge tube so as to face the first surface of the bottom plate. The reinforcing member includes a fixing portion fixed to the side plate and a reinforcing portion connected to the fixing portion. The reinforcing portion is in contact with the second surface of the bottom plate of the housing member.

According to the above lighting device, vibrations due to resonance between the discharge tubes and the bottom plate of the housing member do not occur in the side plate of the housing member. The reinforcing portion is fixed to the side plate through the fixing portion. Therefore, the vibrations of the bottom plate of the housing member due to resonance are suppressed by the reinforcing portion that is in contact with the second surface of the bottom plate. Thus, a buzz sound due to resonance between the discharge tube and the bottom plate is less likely to occur or reduced.

The reinforcing portion may be formed in a plate shape having a surface. The surface of the reinforcing portion and the second surface of the bottom plate of the housing member may extend parallel with each other and may be in contact with each other. With such a configuration, the vibrations of the bottom plate of the housing member are effectively suppressed by the surface of the reinforcing portion.

The side plate may include a plurality of side plates; the fixing portion may include a plurality of fixing portions; the fixing portions may be fixed to the respective side plates of the housing member; and the reinforcing portion of the reinforcing member may be connected to the fixing portions at respective edges of the reinforcing portion. With such a configuration, the reinforcing portion is firmly held with the side plates of the housing member through the fixing portions. This enhances the effect of suppressing vibrations by the reinforcing portion, and thus the vibrations of the bottom plate of the housing member are further suppressed.

The fixing portions may be fixed to at least opposing two of the side plates of the housing member. According to the configuration, the reinforcing portion is provided so as to extend from one side of the bottom plate to the opposite side of the bottom plate. With such a configuration, vibrations of the bottom plate of the housing member are effectively suppressed.

The reinforcing portion of the reinforcing member may be provided along a diagonal of the second surface of the bottom plate. With such a configuration, the reinforcing portion effectively suppresses vibrations of the bottom plate of the housing member.

The reinforcing portion may include a plurality of reinforcing portions. With such a configuration, the reinforcing portions further suppress vibrations of the bottom plate of the housing member.

The fixing portion and the reinforcing portion may be integrally formed. If connection strength between the fixing portion and the reinforcing portion is low, it is difficult to achieve the effect of suppressing vibrations by the reinforcing portion. With such a configuration, while the reinforcing portion suppresses vibrations of the bottom plate of the housing member, the reinforcing portion is not affected by connection strength between the fixing portion and the reinforcing portion. Therefore, the reinforcing portions further suppress the vibrations.

The reinforcing member may be formed from a material having stiffness equal to or greater than that of the housing member. With such a configuration, vibrations of the bottom plate of the housing member are suppressed, and thus the deterioration of the reinforcing member is suppressed.

The technology disclosed in the present invention may be described as a display device including a display panel configured to provide display using light from the lighting device. A display device configured to provide the display panel that is a liquid crystal panel using liquid crystal may be new and useful. A television receiver including the display device may be new and useful. A large display area is included in the display device and the television receiver.

### Advantageous Effect of the Invention

According to the technology disclosed herein, alighting device that hardly or is less likely to produce a buzz sound is provided with a simple configuration.

### BRIEF DESCRIPTION OF THE DRAWINGS

FIG. 1 is an exploded perspective view illustrating a television receiver TV according to a first embodiment;

FIG. 2 is an exploded perspective view illustrating a liquid crystal display device 10;

FIG. 3 is a front view illustrating a backlight unit 24;

FIG. 4 is a rear view illustrating the backlight unit 24;

FIG. 5 is a cross-sectional view illustrating the backlight unit 24 taken along line A-A in FIG. 4;

FIG. 6 is a rear perspective view illustrating the backlight unit 24;

FIG. 7 is a rear view illustrating a backlight unit 74 according to a second embodiment;

FIG. 8 is a rear view illustrating a backlight unit 124 according to a third embodiment;

FIG. 9 is a rear view illustrating a backlight unit 174 according to a fourth embodiment; and

FIG. 10 is an explanatory diagram illustrating driving of a cold cathode fluorescent tube.

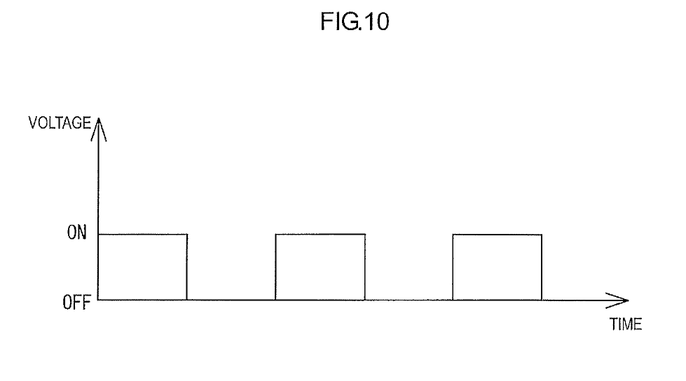

### BEST MODE FOR CARRYING OUT THE INVENTION

### First Embodiment

A first embodiment will be described with reference to drawings. An X-axis, a Y-axis and a Z-axis are described in a part of the drawings, and a direction of each axial direction corresponds to a direction described in each drawing. The Y-axis direction matches a vertical direction and the X-axis direction matches a horizontal direction. Unless otherwise noted, a top to bottom direction will be explained based on a vertical direction.

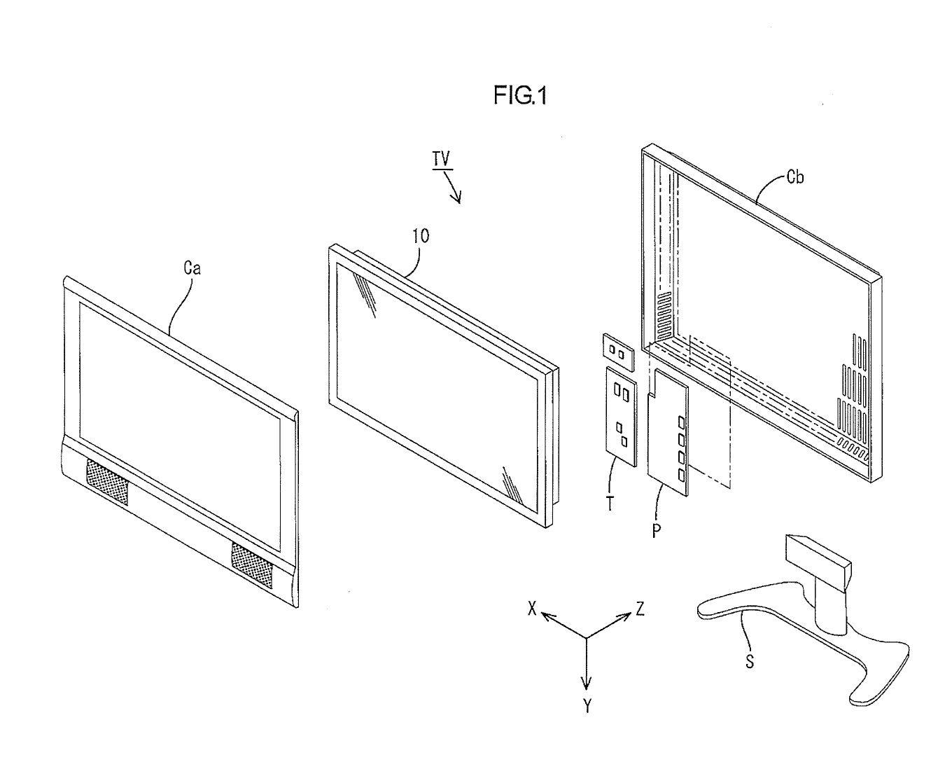

FIG. 1 is an exploded perspective view of the television receiver TV according to the first embodiment. The television receiver TV includes the liquid crystal display device 10, front and rear cabinets Ca, Cb that house the liquid crystal display device D therebetween, a power source P, a tuner T and a stand S.

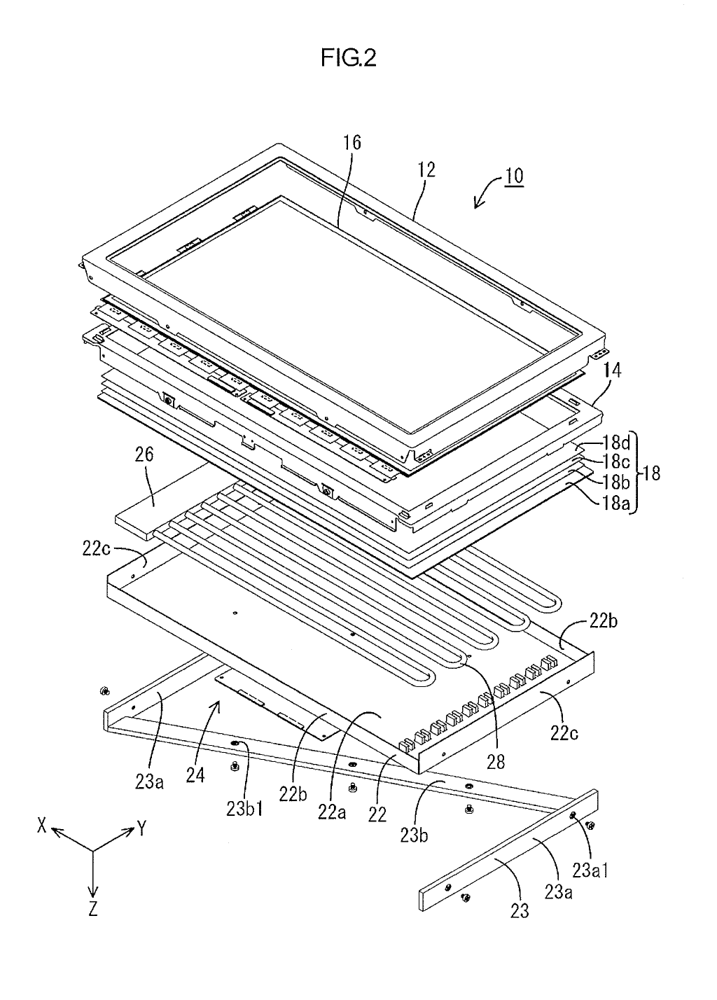

FIG. 2 is an exploded perspective view illustrating the liquid crystal display device 10. An upper side in FIG. 2 corresponds to a front-surface side and a lower side in FIG. 2 corresponds to a rear-surface side. An entire shape of the liquid crystal display device 10 is a landscape rectangular. As illustrated in FIG. 2, the liquid crystal display device 10 includes a liquid crystal panel 16 as a display panel, and a backlight unit 24 as an external light source. The liquid crystal panel 16 and the backlight unit 24 are integrally held by a frame-shaped bezel 12 and the like.

Next, the liquid crystal panel 16 will be explained. The liquid crystal panel 16 is configured such that a pair of transparent (highly capable of light transmission) glass substrates is bonded together with a predetermined gap therebetween and liquid crystal (not illustrated) is sealed between the glass substrates. On one of the glass substrates, switching components (for example, TFTs) connected to source lines and gate lines that are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. A drive circuit board (not illustrated) supplies image data and various control signals that are necessary to display images to the source lines, the gate lines and the counter electrodes. Polarizing plates (not illustrated) are attached to outer surfaces of the substrates.

The backlight unit 24 will be described. As illustrated in FIG. 2, the backlight unit 24 includes a frame 14, optical members 18, the backlight chassis 22 and a reinforcing member 23. The frame 14 is formed in a frame shape and supports the liquid crystal panel 16 along an inner periphery of the frame 14. The optical members 18 include laminated layers of a diffuser plate 18a, a diffuser sheet 18b, a lens sheet 18c and a reflecting type polarizing sheet 18d in sequence from the rear-surface side. The diffuser sheet 18b, the lens sheet 18c and the reflecting type polarizing sheet 18d are configured to convert light emitted from discharge tubes 28 and passed through the diffuser plate 18a to planar light. The discharge tubes 28 will be described later. The liquid crystal panel 16 is provided on the front-surface side of the reflecting type polarizing sheet 18d. The optical members 18 are provided between the discharge tubes 28 and the liquid crystal panel 16.

The substantially box-shaped backlight chassis 22 has an opening on the front-surface side (on the light exit side and the liquid crystal panel 16 side). Specifically, the backlight chassis 22 is made of metal such as aluminum materials and includes the bottom plate 22a and side plates 22b and 22c. The bottom plate 22a has a rectangular plan-view shape. The side plates 22b rise from the respective long sides of the bottom plate 22a. The side plates 22c rise from the respective short sides of the bottom plate 22a. In the following description, a front-side surface of the backlight chassis 22 is referred to as a front surface 22s and a rear-side surface of the backlight chassis 22 is referred to as a rear surface 22t. The reinforcing member 23 will be described later in detail.

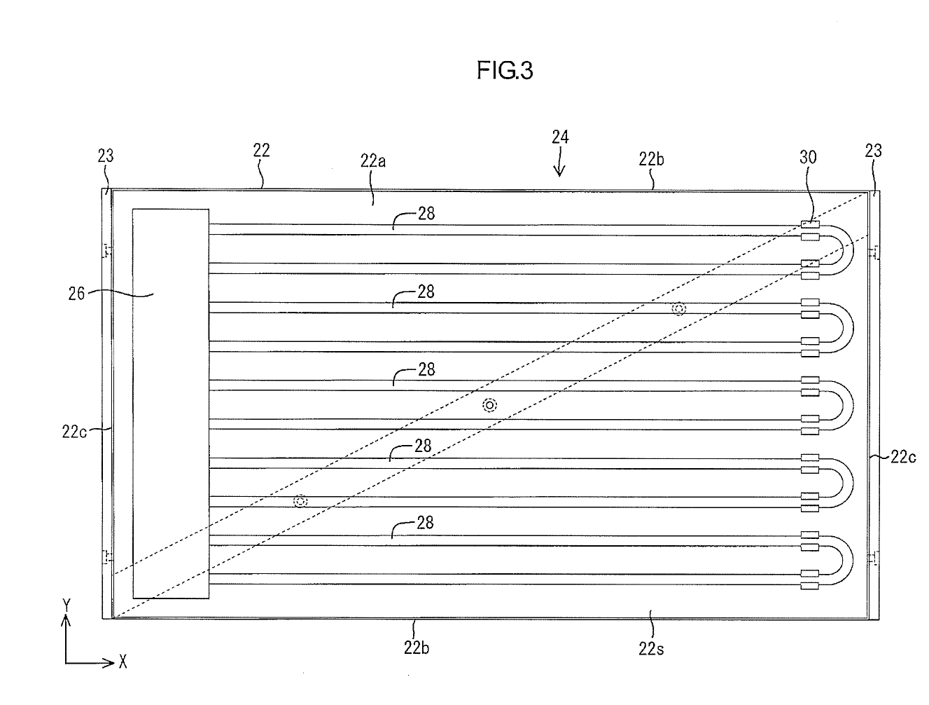

FIG. 3 is a front view of the backlight unit 24. As illustrated in FIG. 3, a power supply board 26 and the five discharge tubes 28 are housed in the backlight chassis 22 (arranged on the front surface 22s side of the backlight chassis 22). The power supply board 26 is formed in a substantially rectangular shape and arranged along one of side edges of the backlight chassis 22. A circuit board and a transformer (neither illustrated) are mounted on the power supply board 26. Each of the five discharge tubes 28 is a cold cathode fluorescent tube and has electrodes (not illustrated) at respective ends thereof. Each discharge tube 28 is formed in a U-shape such that the electrodes are arranged on the same side. The five discharge tubes 28 are arranged in the short-side direction of the backlight chassis 22 (in the Y-axis direction). Portions of each discharge tube 28 near a portion curved in the U-shape are fixed to the bottom plate 22a of the backlight chassis 22 with lamp clips 30. The electrodes of each discharge tube 28 are connected to the power supply board 26. The circuit board and the transformer of the power supply board 30 are configured to supply power to each discharge tube 28 and to adjust an AC voltage that is applied to each discharge tube 28.

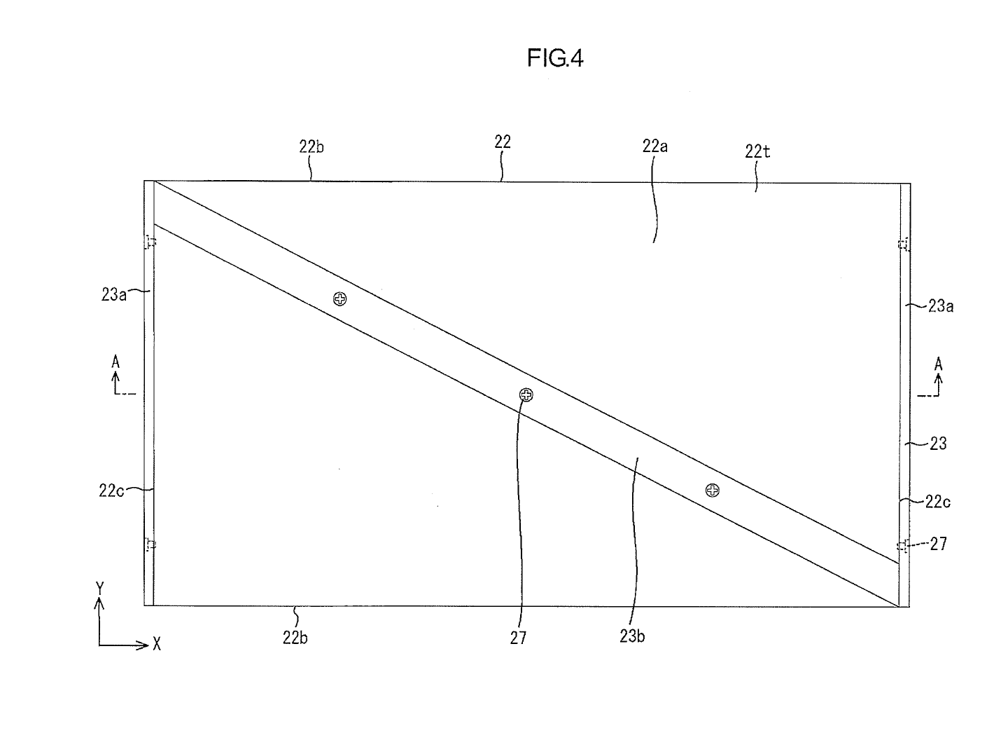

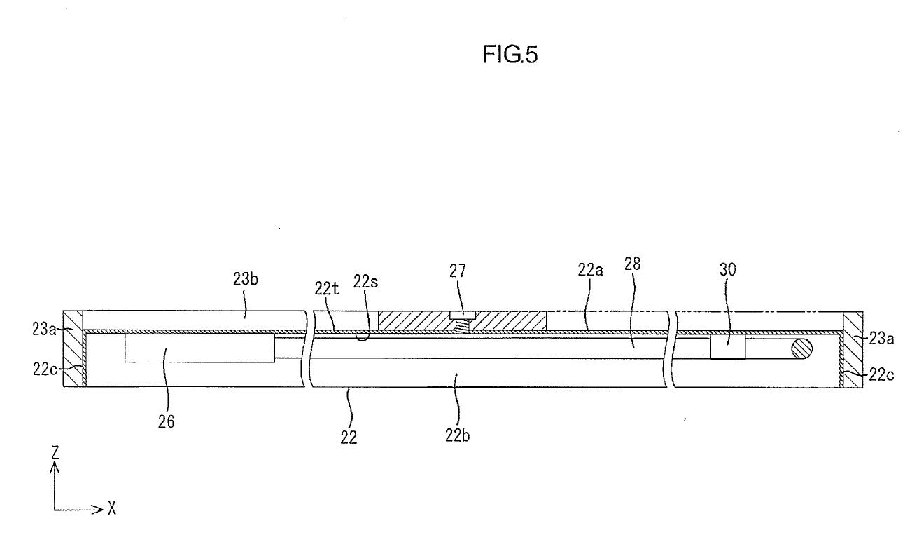

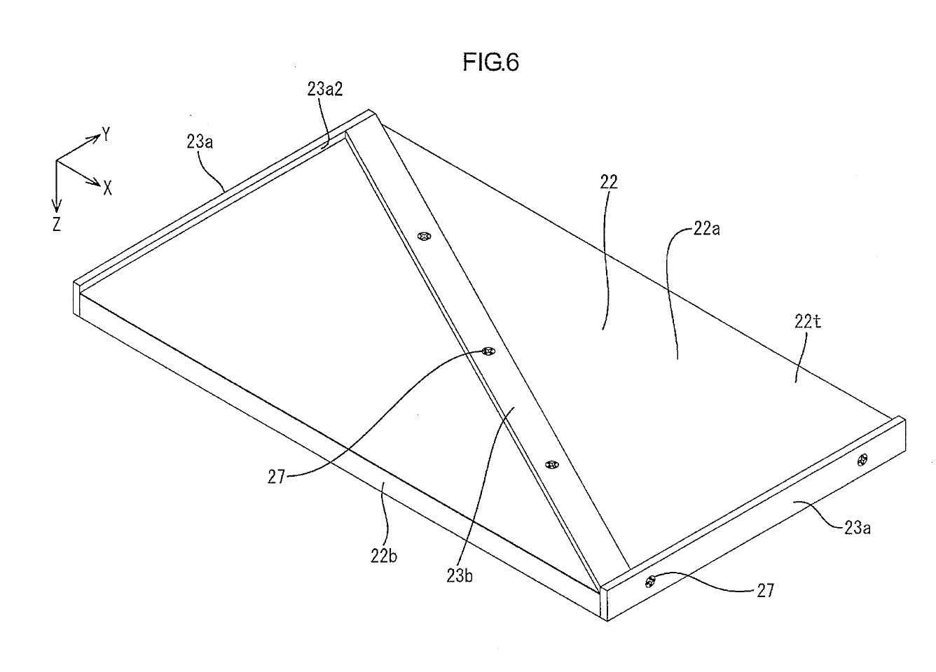

FIG. 4 is a rear view illustrating the backlight unit 24. FIG. 5 is a cross-sectional view of the backlight unit 24 and illustrates a sectional configuration taken along line A-A in FIG. 4. FIG. 6 is a rear perspective view illustrating the backlight unit 24.

The reinforcing member 23 is provided on outer sides of the side plates 22c and a rear surface side of the bottom plate 22. The reinforcing member 23 includes a pair of fixing portions 23a, 23a and a reinforcing portion 23b.

Each of the fixing portions 23a, 23a is formed in a flat-plate shape. Each fixing portion 23a is provided on the outer side of the side plate 22c along the side plate 22c. The side plate 22c extends in the short-side (the Y-axis) direction of the backlight chassis 22. Specifically, the fixing portions 23a, 23a are provided on the outer sides of the respective side plates 22c facing each other in the long-side (the X-axis) direction of the backlight chassis 22. A plurality of fixing portion mounting holes 23a1 are formed through the plate surface of the fixing portions 23a (see FIG. 2). The fixing portion 23a is fastened to the side plate 22c of the backlight chassis 22 with screws 27 through the fixing portion mounting holes 23a1 such that the fixing portion 23a is mounted on the side plate 22c of the backlight chassis 22. The fixing portion 23a is longer in the Z-axis direction than the short side of the side plate 22c that is arranged in the short-side (the Y-axis) direction of the backlight chassis 22. As illustrated in FIG. 6, the fixing portion 23a has an overhang 23a2. The overhang 23a2 is projected more rearward than the rear surface 22t of the bottom plate 22a of the backlight chassis 22.

The reinforcing portion 23c is formed in a flat-plate shape and provided along one of diagonals of the rear surface 22t of the bottom plate 22a of the backlight chassis 22. A plurality of reinforcing portion mounting holes 23b1 are formed through a plate surface of the reinforcing portion 23b (see FIG. 2). The reinforcing portion 23b is fastened to the bottom plate 22a of the backlight chassis 22 with screws 27 through the reinforcing portion mounting holes 23b1 such that the reinforcing portion 23b is mounted on the bottom plate 22a of the backlight chassis 22. Accordingly, the plate surface of the reinforcing portion 23b is in contact with the rear surface 22t of the bottom plate 22a of the backlight chassis 22. The reinforcing portion 23b is connected to the respective overhangs 23a2 of the fixing portions 23a, 23a at edges of the reinforcing portion 23b. Namely, the reinforcing portion 23b is fixed to the side plates 22c of the backlight chassis 22 through the fixing portions 23a.

In the backlight unit 24, the discharge tubes 28 are driven by the PWM method. The discharge tubes 28 and the bottom plate 22a of the backlight chassis 22 cause resonance according to on and off of the pulse signals. The bottom plate 22a of the backlight chassis 22 vibrates due to the resonance. The side plates 22b, 22c of the backlight chassis 22 do not cause resonance, and thus the side plates 22b, 22c do not vibrate. The reinforcing portion 23b is connected to the fixing portions 23a that are fixed to the side plates 22c. In addition, the reinforcing portion 23b is in contact with the rear surface 22t of the bottom plate 22a of the backlight chassis 22. With such a configuration, vibrations of the bottom plate 22a are less likely to occur or suppressed by the reinforcing portion 23b.

As described above, in the backlight unit 24 according to the present embodiment, the side plates 22c that are arranged in the short-side direction do not vibrate due to resonance between the discharge tubes 28 and the bottom plate 22a. The reinforcing portion 23b is fixed to the side plates 22c through the fixing portions 23a and in contact with the rear surface 22t of the bottom plate 22a of the backlight chassis 22. With such a configuration, the reinforcing portion 23b that is in contact with the bottom plate 22a suppresses the vibrations of the bottom plate 22a due to resonance. As a result, a buzz sound due to resonance between the bottom plate 22a and the discharge tubes 28 is less likely to occur or reduced.

In the backlight unit 24 according to the present embodiment, a surface of the plate-shaped reinforcing portion 23b is in contact with the rear surface 22t of the bottom plate 22a of the backlight chassis 22 while the reinforcing portion 23b is arranged parallel to the rear surface 22t. With such a configuration, vibrations of the bottom plate 22a of the backlight chassis 22 are effectively suppressed by the surface of the reinforcing portion 23b.

In the backlight unit 24 according to the present embodiment, the reinforcing member 23 includes the two fixing portions 23a. The fixing portions 23a are fixed to the respective side plates 22c, 22c of the backlight chassis 22. The reinforcing portion 23b of the reinforcing member 23 is connected to the different fixing portions 23a at the respective edges of the reinforcing portion 23b. Accordingly, the reinforcing portion 23b is firmly fixed to the side plates 22c of the backlight chassis 22 through the two fixing portions 23a, 23a. This enhances the effect of suppressing vibrations of the bottom plate 22a of the backlight chassis 22 by the reinforcing portion 23b, and this further suppresses vibrations of the bottom plate 22a.

In the backlight unit 24 according to the present embodiment, the two fixing portions 23a, 23a are fixed to at least the respective side plates 22c, 22c facing each other in the long-side direction of the backlight chassis 22. Accordingly, the reinforcing portion 23b is provided over from one side of the bottom plate 22a to the opposite side of the bottom plate 22a. With such a configuration, vibrations of the bottom plate 22a of the backlight chassis 22 are effectively suppressed.

In the backlight unit 24 according to the present embodiment, the reinforcing portion 23b of the reinforcing member 23 is provided along a diagonal of the rear surface 22t the bottom plate 22a. With such a configuration, the reinforcing portion 23b effectively suppresses vibrations of the bottom plate 22a of the backlight chassis 22.

In these days, the bottom plate 22a of the backlight chassis 22 tends to be produced in a smaller thickness in order to reduce weight and cost, for example. Stiffness of the bottom plate 22a is decreased by reducing the thickness of the bottom plate 22a of the backlight chassis 22. Even if the stiffness of the bottom plate 22a of the backlight chassis 22 is poor, a buzz sound is less likely to occur or reduced in the backlight unit 24 according to the present embodiment.

### Second Embodiment

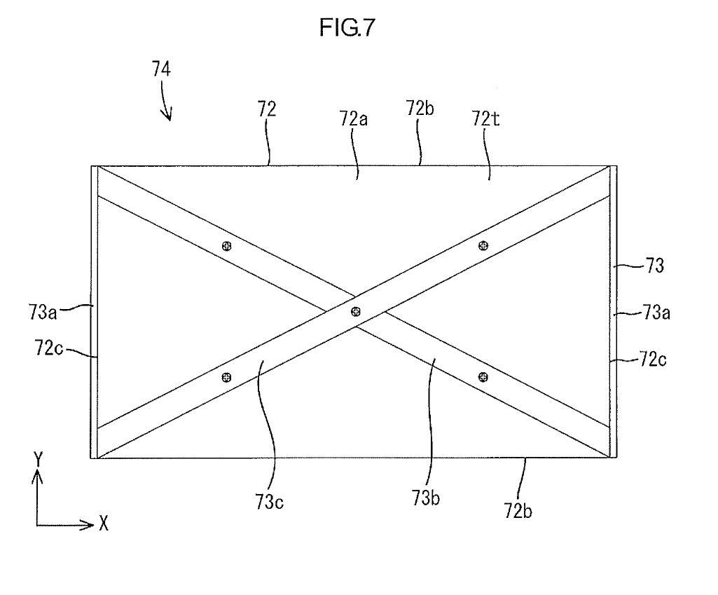

A second embodiment will be described with reference to drawings. FIG. 7 is a rear view illustrating the backlight unit 74 according to the second embodiment. In the second embodiment, the reinforcing member includes reinforcing portions different in number and material from the first embodiment. Other components are the same as those in the first embodiment, and thus the construction, operations and effects thereof will not be explained. The members in FIG. 7 denoted by reference numerals that fifty is added to the reference numerals in FIG. 4 are the same members explained in the first embodiment.

In the backlight unit 74 according to the second embodiment, a reinforcing member 73 includes a pair of fixing portions 73a, 73a and two reinforcing portions 73b, 73c. The reinforcing member 73 is formed from a material having stiffness equal to or greater than that of a backlight chassis 72. The two reinforcing portions 73b, 73c are provided along diagonals of a rear surface 72t of the bottom plate 72a of the backlight chassis 72. The two reinforcing portions 73b, 73c are connected to the respective fixing portions 73a at the edges of the reinforcing portions 73b, 73c. The fixing portions 73a are fixed to the respective side plates 72c that are provided on the respective short sides of the bottom plate of the backlight chassis 72 (namely, the side plates 72c that extend in the Y-axis direction).

In the backlight unit 74 according to the second embodiment, the reinforcing member 73 includes a plurality of reinforcing portions 73b, 73c. Therefore, the reinforcing portions 73b, 73c further suppress vibrations of the bottom plate 72t of the backlight chassis 72.

Furthermore, in the backlight unit 74 according to the second embodiment, the reinforcing member 73 is formed from a material having stiffness equal to or greater than that of the backlight chassis 72. This suppresses the deterioration of the reinforcing member 73 that may occur due to suppression of vibrations of the bottom plate 72a of the backlight chassis 72.

### Third Embodiment

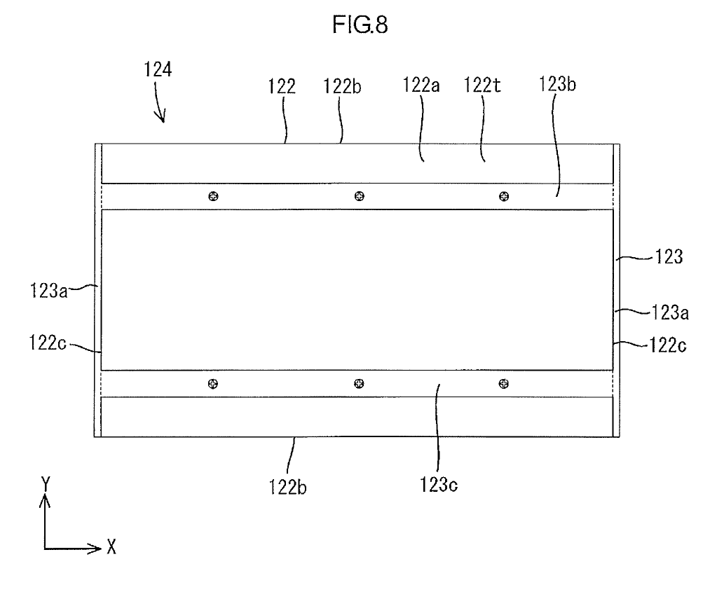

A third embodiment will be described with reference to drawings. FIG. 8 is a rear view illustrating the backlight unit 124 according to the third embodiment. In the third embodiment, the reinforcing member includes reinforcing portions different in number and arrangement from the first embodiment. In addition, fixing portions and reinforcing portions are connected differently from the first embodiment. Other components are the same as those in the first embodiment, and thus the construction, operations and effects thereof will not be explained. The members in FIG. 8 denoted by reference numerals that one hundred is added to the reference numerals in FIG. 4 are the same members explained in the first embodiment.

In the backlight unit 124 according to the third embodiment, the reinforcing member 123 includes a pair of fixing portions 123a, 123a and two reinforcing portions 123b, 123c. The fixing portions 123a, 123a and two reinforcing portions 123b, 123c are integrally formed. The reinforcing portions 123b, 123c are provided on a rear surface 122t of the bottom plate 122a of the backlight chassis 122 and arranged along the long-side direction (in the X-axis direction) of the backlight chassis 122. The fixing portions 123a are connected to the edges of the reinforcing portions 123b, 123c. The fixing portions 123a are fixed to the respective side plates 122c that extend in the short-side direction (in the Y-axis direction) of the backlight chassis 122. With such a configuration of the reinforcing portions 123b, 123c of the reinforcing member 123, the reinforcing portion 123b suppresses vibrations of the bottom plate 122a of the backlight chassis 122 due to resonance.

Moreover, in the backlight unit 124 according to the third embodiment, the fixing portions 123a, 123a and the reinforcing portions 123b, 123c are integrally formed. With such a configuration, when the reinforcing portions 123b, 123c suppress vibrations of the bottom plate 122a of the backlight chassis 72, the reinforcing portions 123b, 123c are not affected by connection strength between the reinforcing portions 123b, 123c and the fixing portions 123a, 123a. Therefore, reinforcing portions 123b, 123c further suppress the vibrations.

### Fourth Embodiment

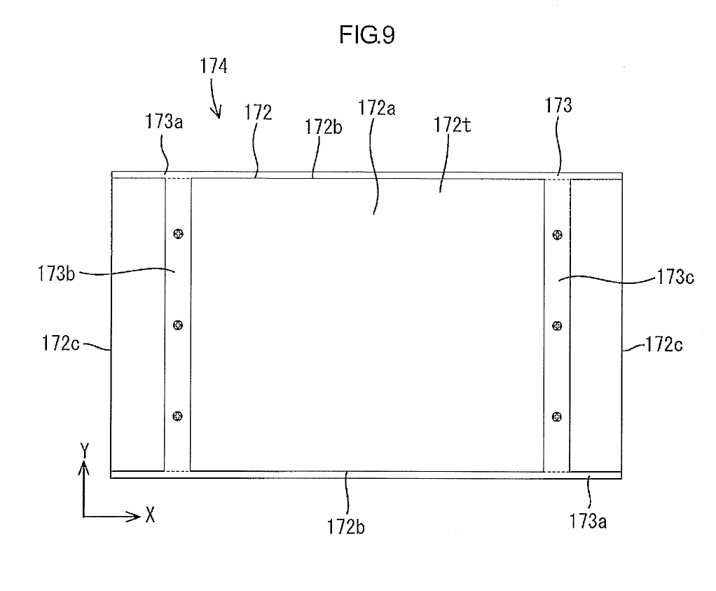

A fourth embodiment will be described with reference to drawings. FIG. 9 is a rear view illustrating the backlight unit 174 according to the fourth embodiment. In the fourth embodiment, a reinforcing member includes reinforcing portions different in number and arrangement and fixing portions different in arrangement from those of the first embodiment. The reinforcing portions and the fixing portions in the fourth embodiment are connected differently from that in the first embodiment. Other components are the same as those in the first embodiment, and thus the construction, operations and effects thereof will not be explained. The members in FIG. 9 denoted by reference numerals that one hundred and fifty is added to the reference numerals in FIG. 4 are the same members explained in the first embodiment.

In the backlight unit 174 according to the fourth embodiment, the reinforcing member 173 includes a pair of fixing portions 173a, 173a and two reinforcing portions 173b, 173c. The fixing portions 173a, 173a and the reinforcing portions 173b, 173c are integrally formed. The flat-plate-shaped fixing portions 173a, 173a are provided along the outer surfaces of the side plates 172b that extend in the long-side direction (the X-axis direction) of the backlight chassis 172. The reinforcing portions 173b, 173c are provided on a rear surface 172t of the bottom plate 172a of the backlight chassis 172 and arranged along the respective short sides (in the Y-axis direction) of the backlight chassis 172. The reinforcing portions 173b, 173c are connected at the edges thereof to the fixing portions 173a. The fixing portions 173a are fixed to the respective side plates 172c that extend in the short-side (the Y-axis) direction of the backlight chassis 172. Even though the reinforcing portions 173b, 173c of the reinforcing member 173 are arranged as such, the reinforcing portion 173b suppresses vibrations of the bottom plate 172a of the backlight chassis 172 due to resonance. Moreover, the fixing portions 173a, 173a and the reinforcing portions 173b, 173c are integrally formed. Therefore, effect of suppressing vibrations by the reinforcing portions 173b, 173c is improved.

Correspondence relationships between the construction of the embodiments and the construction of the present invention will be described. The front surface 22s, 72s, 122s, 172s is an example of a “first surface.” The rear surface 22t, 72t, 122t, 172t is an example of a “second surface.” The backlight chassis 22, 72, 122, 172 is an example of a “housing member.”

Modification examples of the above embodiments will be explained.

(1) In the embodiments, the discharge tube is the cold cathode fluorescent tube. The discharge tube may be other type of discharge tube that may produce resonance with the backlight chassis.

(2) In the embodiments, the five U-shaped discharge tubes are housed in the backlight chassis. However, the shape and the number of discharge tubes are not limited to the embodiments.

(3) In addition to the embodiments, the number and arrangement of the fixing portions and the reinforcing portions included in the reinforcing member may be altered if necessary.

(4) In the above embodiments, the liquid crystal display device includes the liquid crystal panel as a display panel. The technology can be applied to display devices including other types of display components.

(5) In the above embodiments, the television receiver including the tuner is used. However, the technology can be applied to a display device without a tuner.

The embodiments according to the present invention have been described in detail. The embodiments are for illustrative purposes only and by no means limit the scope of the present invention. Technology described in the present invention includes variations and modifications of the embodiments and examples described above.

The technical elements described or illustrated in the specification or drawings exhibit the technical usefulness individually or in various combinations thereof. The technical elements are not limited to the combinations defined in the claims at the time of filing the application. Furthermore, the technology illustrated in the specification or drawings realizes a plurality of purposes at the same time and have a technical usefulness when one of the purposes is realized.

### EXPLANATION OF SYMBOLS

TV: television receiver, Ca, Cb: cabinet, T: tuner, S: stand, 10: liquid crystal display device, 12: bezel, 14: frame, 16: liquid crystal panel, 18: optical members, 18a: diffuser plate, 18b: diffuser sheet, 18c: lens sheet, 18d: reflecting type polarizing sheet, 22,72,122,172: backlight chassis, 22a,72a,122a,172a: bottom plate, 22b,72b,122b,172b: side plate (in the long-side direction), 22c,72c,122c,172c: side plate (in the short-side direction) 22s: front surface (of the bottom plate), 22t,72t,122t,172t: rear surface (of the bottom plate), 23,73,123,173: reinforcing member, 23a,73a,123a,173a: fixing portion, 23b,73b,123b,173b: reinforcing portion, 23a1: fixing portion mounting hole, 23b1: reinforcing portion mounting hole, 23a2: overhang, 24,74,124,174: backlight unit, 26: power supply board, 27: screw, 28: discharge tube, 30: lamp clip

1. A lighting device comprising:
a discharge tube;
a housing member including a side plate and a bottom plate having a first surface and a second surface, the side plate rising from the first surface of the bottom plate at an edge of the bottom plate, the housing member housing the discharge tube so as to face the first surface of the bottom plate; and
a reinforcing member including a fixing portion fixed to the side plate and a reinforcing portion connected to the fixing portion, the reinforcing portion being in contact with the second surface of the bottom plate of the housing member.

2. The lighting device according to claim 1, wherein:
the reinforcing portion is formed in a plate shape having a surface; and
the surface of the reinforcing portion and the second surface of the bottom plate of the housing member extend parallel with each other and are in contact with each other.

3. The lighting device according to claim 1 one of claims 1 and 2, wherein:
the side plate includes a plurality of side plates;
the fixing portion included in the reinforcing member includes a plurality of fixing portions;
the fixing portions are fixed to the respective side plates of the housing member; and
the reinforcing portion of the reinforcing member is connected to the fixing portions at respective edges of the reinforcing portion.

4. The lighting device according to claim 3, wherein the fixing portions are fixed to at least opposing two of the side plates of the housing member.

5. The lighting device according to claim 1 any one of claims 1, wherein the reinforcing portion of the reinforcing member is provided along a diagonal of the second surface of the bottom plate.

6. The lighting device according to claim 1, wherein the reinforcing portion included in the reinforcing member includes a plurality of reinforcing portions.

7. The lighting device according to claim 1, wherein the fixing portion and the reinforcing portion are integrally formed.

8. The lighting device according to claim 1, wherein the reinforcing member is formed from a material having stiffness equal to or greater than that of the housing member.

9. A display device comprising:
the lighting device according to claim 1; and
a display panel configured to provide display using light from the lighting device.

10. The display device according to claim 9, wherein the display panel is a liquid crystal panel using liquid crystals filled between base boards.

11. A television comprising the display device according to claim 9.
